(19) United States
(12) Patent Application Publication
(10) Pub. No.: US 2014/0122461 A1
(43) Pub. Date: May 1, 2014

(54) SYSTEMS AND METHODS FOR MERGING PARTIALLY AGGREGATED QUERY RESULTS

(71) Applicant: Anurag Singla, Cupertino, CA (US)

(72) Inventor: Anurag Singla, Cupertino, CA (US)

(21) Appl. No.: 14/125,785

(22) PCT Filed: Jun. 30, 2011
(86) PCT No.: PCT/US2011/042726

§ 371 Date: Dec. 12, 2013

(51) Int. Cl. G06F 17/30

(52) U.S. Cl. CPC G06F 17/30477
USPC 707/722

(57) ABSTRACT

Systems and methods for merging partially aggregated query results are provided. A partially aggregated query result is determined. Each query of a plurality of queries is executed on a plurality of events at a defined schedule and a time duration. A key and a value of the partially aggregated query result are identified. It is determined whether a function for the partially aggregated query result is identified. If so, a related partially aggregated query result is determined using the key. The partially aggregated query result is merged with the related partially aggregated query result.

### I. BACKGROUND

The field of security information/event management (SIM or SIEM) is generally concerned with 1) collecting data from networks and networked devices that reflects network activity and/or operation of the devices and 2) analyzing the data to enhance security. For example, the data can be analyzed to identify an attack on the network or a networked device and determine which user or machine is responsible. If the attack is ongoing, a countermeasure can be performed to thwart the attack or mitigate the damage caused by the attack. The data that is collected usually originates in a message (such as an event, alert, or alarm) or an entry in a log file, which is generated by a networked device. Networked devices include firewalls, intrusion detection systems, and servers.

Each message or log file entry (“event”) is stored for future use. Security systems may also generate events, such as correlation events and audit events. Together with messages and log file entries, these and other events are also stored on disk. In an average customer deployment, one thousand events per second may be generated. This amounts to 100 million events per day or three billion events per month. The analysis and processing of such a vast amount of data can incur significant load on the security system, causing delays in reporting results.

### II. BRIEF DESCRIPTION OF THE DRAWINGS

The present disclosure may be better understood and its numerous features and advantages made apparent by referencing the accompanying drawings.

FIG. 1 is a topological block diagram network security system in accordance with an embodiment.

FIG. 2 is a process flow diagram for merging of related partially aggregated trend results in accordance with an embodiment.

FIG. 3A is a topological block diagram of a network security system including a dedicated manager of a plurality of managers in accordance with an embodiment.

FIG. 3B is a topological block diagram of a network security system including a master manager of a plurality of managers in accordance with an embodiment.

FIG. 4 is a process flow diagram for merging a persisted aggregated trend result and an in-memory aggregated trend result based on a detected trigger condition in accordance with an embodiment.

FIG. 5 illustrates a computer system in which an embodiment may be implemented.

### III. DETAILED DESCRIPTION

Security systems may offer reports to the end user that can be used to track various data points, such as the count of login attempts, top users with successful and failed login attempts, top inbound or outbound blocked sources and destinations, and configuration changes to networked devices. Generally, a report provides summary information on these and other events involving networked devices in a customer environment that is under the purview of the security system. Unless otherwise indicated, a networked device includes both network-attached devices (e.g., network management systems) and network infrastructure devices (e.g., network switch, hub, router, etc.)

To produce a report, multiple queries may be run against events that are persisted in a data store. As used herein, an event is a message, log file entry, correlation event, audit event, etc. Events are further described in U.S. application Ser. No. 11/966,078, filed Dec. 28, 2007, which is incorporated by reference herein in its entirety. Since the volume of event data in the customer environment can be quite large, often times in terabytes, the amount of processing involved imposes a significant load on the security system.

Moreover, where multiple reports are sought at the same time (e.g., monthly, quarterly, etc.), the load on the security system is multiplied, which may cause delays in generating the reports. For example, the processing of events for a monthly report may begin at the end of the month. If multiple monthly reports are requested, the security system may experience a spike in the load at the end of the month.

Load on the security system is also caused, in part, by individually and separately executing each query on the events. In other words, the same event is read from disk many times to compute a result for each individual query. This type of read-many and evaluate-many model is inefficient.

Trends enable customers to track various activities, such as security-related activities. A trend executes a specified query on a defined schedule and time duration to calculate aggregated results over the specified time duration. The trend maintains aggregate data in a data store. For example, each trend maintains the aggregate data in its own database table in the data store. Each trend issues a single query and saves an aggregation of the query results in the associated trend table. Moreover, each trend is associated with a frequency and duration or time interval during which the query is applied on the events. A security system may be preconfigured with multiple trends. Trends may also be user-configurable.

Trends may be used to generate reports. For example, an hourly trend (i.e., with a duration of one hour) measures the top bandwidth consumers, i.e., measures the number of bytes of data received and sent by a set of networked devices under the purview of the security system. The trend results may be persisted in a table of a database, and each record in the trend table represents the count of bytes for an hour in the day per networked device. If the user issues a query to the security system expressing interest in the data from 9:00 am-12:00 pm for the last month, records in the table corresponding to those hours for each day in the month may be used to provide the report.

As described herein, a trend is computed by applying an associated query on an event as it is streamed to a trend processing module in a network security system. In one embodiment, the trend is computed in-memory as described in PCT Application Ser. No. PCT/US2011/034674, filed Apr. 2, 2011, which is incorporated by reference herein in its entirety. The query results are aggregated and periodically persisted to a data store. The aggregated trend results amortize over a longer duration of time the cost of running a report. In other words, the aggregated trend results represent a pre-processing of the events.

Based on the deployment of the security system, partially aggregated trend results are generated and merged in-memory, producing another partially aggregated trend result or a complete trend result, which may then be persisted. As used herein, a partially aggregated trend result is a trend result that is calculated on a subset, of all relevant events (e.g., partial set of events) in the security system. Partially aggregated trend results may be generated, for example, by various components in a distributed computing deployment of the security system, and provided to a trend aggregation module for merging. Moreover, providing real-time trend results may include in-memory merging of partially aggregated trend results. Furthermore, late or out-of-order events may trigger the merging of partially aggregated trend results.

When it comes time to provide a monthly report, for example, at the end of the month, the amount of further processing is reduced since some of the data has already been pre-computed. Furthermore, since the merging of the partially aggregated trend result occurs in-memory, the amount of disk access is reduced, thereby reducing the load on the security system.

Systems and methods for merging partially aggregated query results are provided. A partially aggregated query result is determined. Each query of a plurality of queries is executed on a plurality of events at a defined schedule and a time duration. A key and a value of the partially aggregated query result are identified. It is determined whether a function for the partially aggregated query result is identified. If so, a related partially aggregated query result is determined using the key. The partially aggregated query result is merged with the related partially aggregated query result.

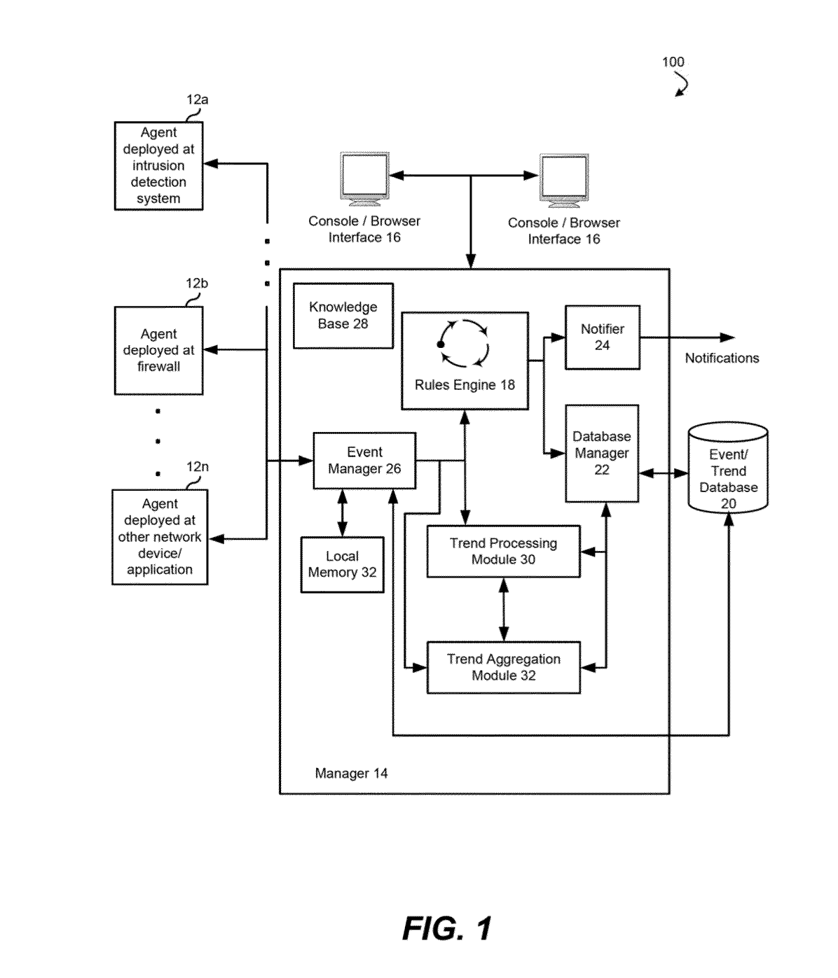

FIG. 1 is a topological block diagram of a network security system 100 in accordance with an embodiment. System 100 includes agents 12a-n, at least one manager 14 and at least one console 16 (which may include browser-based versions thereof). In some embodiments, agents, managers and/or consoles may be combined in a single platform or distributed in two, three or more platforms (such as in the illustrated example). The use of this multi-tier architecture supports scalability as a computer network or system grows.

Agents 12a-n are software programs, which are machine readable instructions, that provide efficient, real-time (or near real-time) local event data capture and filtering from a variety of network security devices and/or applications. The typical sources of security events are common network security devices, such as firewalls, intrusion detection systems and operating system logs. Agents 12a-n can collect events from any source that produces event logs or messages and can operate at the native device, at consolidation points within the network, and/or through simple network management protocol (SNMP) traps.

Agents 12a-n are configurable through both manual and automated processes and via associated configuration files. Each agent 12 may include at least one software module including a normalizing component, a time correction component, an aggregation component, a batching component, a resolver component, a transport component, a trend processing module, and/or additional components. These components may be activated and/or deactivated through appropriate commands in the configuration file.

In particular, agents 12a-n may include a trend processing module, which is configured to receive a set of events from a source, process the events by applying a filter associated with a trend on each event, and aggregate the trend results. An agent operates on events which it receives and does not have information on the events received by other agents. As such, the aggregated data provided by an agent is a trend result that is based on a partial set of events (e.g., partially aggregated trend result). Trend processing module is also configured to provide event data messages comprising the partially aggregated trend results to manager 14 via event manager 22. In one embodiment, at least one of agents 12a-n do not include a trend processing module and provide event data messages comprising event data, rather than partially aggregated trend results, to manager 14 via event manager 22.

Manager 14 may be comprised of server-based components that further consolidate, filter and cross-correlate events received from the agents, employing a rules engine 18 and a centralized event and trend database 20. One role of manager 14 is to capture and store all of the real-time and historic event data to construct (via database manager 22) a complete, enterprise-wide picture of security activity. The manager 14 also provides centralized administration, notification (through at least one notifier 24), and reporting, as well as a knowledge base 28 and case management workflow. The manager 14 may be deployed on any computer hardware platform and one embodiment uses a database management system to implement the event data store component. Communications between manager 14 and agents 12a-n may be bi-directional (e.g., to allow manager 14 to transmit commands to the platform hosting agents 12a-n) and encrypted. In some installations, managers 14 may act as concentrators for multiple agents 12a-n and can forward information to other managers (e.g. deployed at a corporate headquarters).

Manager 14 also includes at least one event manager 26, which is responsible for receiving the event data messages transmitted by agents 12a-n and/or other managers. Event manager 26 is also responsible for generating event data messages such as correlation events and audit events. Where bi-directional communication with agents 12a-n is implemented, event manager 26 may be used to transmit messages to agents 12a-n. If encryption is employed for agent-manager communications, event manager 26 is responsible for decrypting the messages received from agents 12a-n and encrypting any messages transmitted to agents 12a-n.

Consoles 16 are computer—(e.g., workstation—) based applications that allow security professionals to perform day-to-day administrative and operation tasks such as event monitoring, rules authoring, incident investigation and reporting. Access control lists allow multiple security professionals to use the same system and event and trend database, with each having their own views, correlation rules, alerts, reports and knowledge base appropriate to their responsibilities. A single manager 14 can support multiple consoles 16.

In some embodiments, a browser-based version of the console 16 may be used to provide access to security events, knowledge base articles, reports, notifications and cases. That is, the manager 14 may include a web server component accessible via a web browser hosted on a personal or handheld computer (which takes the place of console 16) to provide some or all of the functionality of a console 16. Browser access is particularly useful for security professionals that are away from the consoles 16 and for part-time users. Communication between consoles 16 and manager 14 is bi-directional and may be encrypted.

Through the above-described architecture, a centralized or decentralized environment may be supported. This is useful because an organization may want to implement a single instance of system 100 and use an access control list to partition users. Alternatively, the organization may choose to deploy separate systems 100 for each of a number of groups and consolidate the results at a “master” level. Such a deployment can also achieve a “follow-the-sun” arrangement where geographically dispersed peer groups collaborate with each other bypassing oversight responsibility to the group currently working standard business hours. Systems 100 can also be deployed in a corporate hierarchy where business divisions work separately and support a roll-up to a centralized management function.

The network security system 100 also includes trend processing capabilities. In one embodiment, manager 14 further includes a trend processing module 30 and a local memory 32. Trend processing module 30 is configured to receive a set of events, such as security events from at least one of agents 12a-n via event manager 26, from event and trend database 20 via the database manager 22, or from the event manager 26 itself. The set of events may be read into local memory 32. Local memory 32 may be any appropriate storage medium and may be located on manager 14 itself, in a cluster containing manager 14, or on a network node accessible to manager 14. Trend processing module 30 is further configured to process the events, for example in-memory (e.g., in local memory 32), by applying a filter associated with a trend on each event, and aggregating the trend results. Trend processing module 30 is also configured to provide partially aggregated trend results to a trend aggregation module, such as trend aggregation module 32.

Trend aggregation module 32 is configured to receive a set of partially aggregated trend results from at least one of agents 12a-n via event manager 26, trend processing module 30, from event and trend database 20 via the database manager 22, or from other managers. The set of partially aggregated trend results may be read into local memory 32. Trend aggregation module 30 is further configured to generate another partially aggregated trend result or a complete trend result by merging, for example in-memory (e.g., in local memory 32), those partially aggregated trend results that are determined to be related.

As previously described, a trend is a task scheduled to periodically run a query, the aggregated results of which are periodically stored, for example in a database table associated with that particular trend. Trends may be employed for providing reports to a network administrator or other analyst using the network security system 100.

In operation, agents 12a-n may provide events and/or partially aggregated data. In one example, agents 12a-n provide events, which are received in an event stream by event manager 26 and passed to rules engine 18 and trend processing module 30 for processing. Furthermore, events generated by manager 14 via event manager 26 are also passed to rules engine 18 and trend processing module 30 for processing. As used herein, an event stream is a continuous flow of events. Event data received from agents 12a-n or generated by manager 14 are stored in an event table of database 20 via database manager 22.

In another example, agents 12a-n provide partially aggregated data to trend aggregation module 32, which are received in a stream by event manager 26 and passed to trend aggregation module 32 for processing.

Upon receiving an event, trend processing module 30 filters the event according to the conditions and computed fields. The conditions applied may be the unique conditions of the set of query conditions. Likewise, the computed fields applied may be the unique computed fields. For an event that passes the filter, each query is evaluated on that event. The result of each query is held in memory of manager 14. The query results are aggregated for multiple events as an aggregated trend result, which is stored in a trend table of database 20 or provided in a stream to trend aggregation module 32 where the aggregated data is a partially aggregated trend result.

Trend aggregation module 32 receives partially aggregated trend results and generates a partially aggregated trend result or a complete trend result by determining which of the partially aggregated trend results are related, and merging the related partially aggregated trend results. The complete trend result is stored in a trend table of database 20. The newly generated partially aggregated trend result may be provided to another manager for further merging. In one embodiment, each trend is associated with its own table in database 20.

When it comes time to provide a report, the trend tables of database 20 are queried and the relevant pre-computed data (i.e., complete trend results or partially aggregated trend results) are retrieved. As such, a read-once and evaluate-many model is described herein. The load on the system is significantly reduced by reducing the amount of disk access and by distributing the evaluation of events on agents.

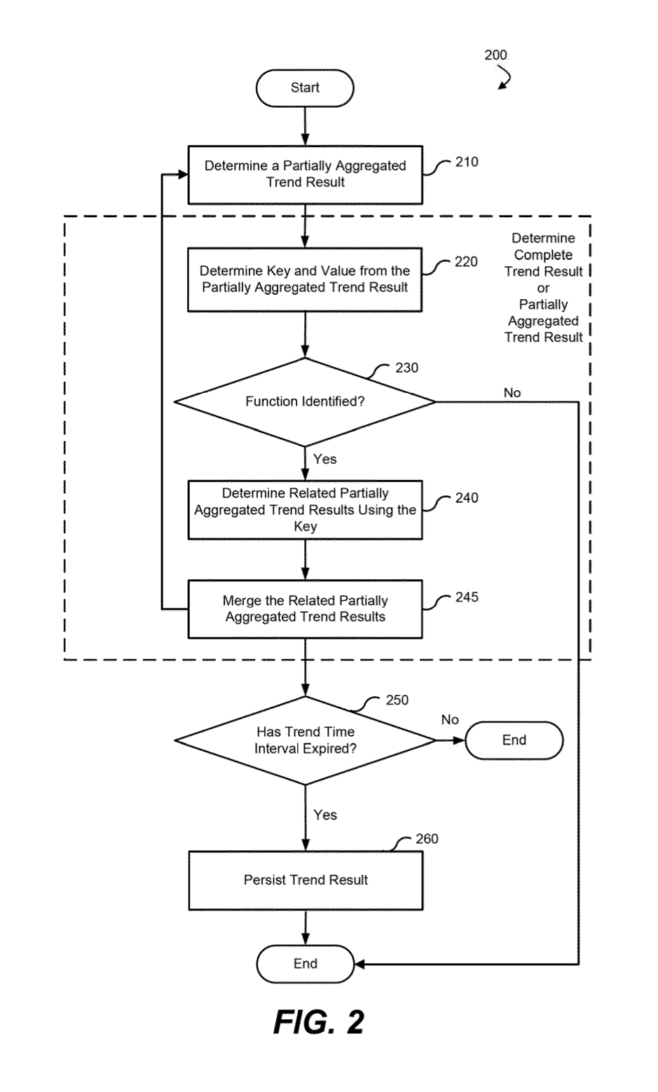

FIG. 2 is a process flow diagram for merging of related partially aggregated trend results in accordance with an embodiment. The depicted process flow 200 may be carried out by execution of sequences of executable instructions. In another embodiment, various portions of the process flow 200 are carried out by components of a network security system, an arrangement of hardware logic, e.g. an Application-Specific Integrated Circuit (ASIC), etc. For example, blocks of process flow 200 may be performed by execution of sequences of executable instructions in a trend aggregation module of the network security system. The trend aggregation module may be deployed, for example, at a manager in the network security system.

Trend reporting capabilities enable customers to track activity over a specified period of time to identify, for example, changes in risks or threats in the networked devices. The performance for generating regularly-scheduled reports is improved, in part, by evaluating partially aggregated trend results upon arrival in memory.

As previously described, each trend is associated with a query. An aggregated trend result is the query result over events received by the particular device (e.g. agent, manager, etc.) for the duration of the trend interval. The same query is evaluated on multiple events, and the result of each evaluation is aggregated, providing a single combined result (i.e., aggregated trend result).

As previously described, a partially aggregated trend result is an aggregated trend result that is calculated on a subset of all relevant events in the security system. In one embodiment, partially aggregated trend results may be combined with other partially aggregated trend results, producing a complete aggregation of the trend results or another partially aggregated trend result. As used herein, the complete aggregation is the trend result that is reflective of all events in the security system for that particular trend.

At step 210, a partially aggregated trend result is determined. Partially aggregated trend results may be received by the manager and generated by agents in the network security system, a trend processing module at the manager, or by modules in other managers in the network security system.

For example, during a connection establishment process (handshake) between an agent and a manager, agents that support generation of partially aggregated trend results are determined. Each of these agents then provide (e.g., in a stream) partially aggregated trend results based on the events that it receives. Moreover, a trend processing module at the same manager of the trend aggregation module may generate partially aggregated trend results.

Furthermore, other managers may also generate partially aggregated trend results. In a distributed computing environment, multiple managers may be employed to process events, where each manager receives a set of events or partially aggregated trend results from its sources. For load-balancing, each event or partially aggregated trend result may be directed to a single manager of a plurality of managers in the network security system for final merging. As such, managers that do not perform the final merging (i.e., non-final managers) receive and process a subset of all events in the distributed deployment of the security system. During configuration of the security system, the non-final managers may be configured to generate partially aggregated trend results from events, generate partially aggregated trend results from other partially aggregated trend results (for example as received by agents or other lower-level managers), and/or forward trend results to a dedicated or master manager for merging.

A complete trend result, or another partially aggregated trend result is determined. At step 220, a key and value are determined for each record in the received partially aggregated trend result. In one embodiment, the keys are identified, for example, by the manner in which the result is organized into groups (e.g., according to a GROUP BY clause in the associated trend query). If there is no such grouping, the default key is determined to be a NULL value.

The value associated with the key is identified in the partially aggregated trend result. For example, a partially aggregated trend result specifies that a source IP address 1.1.1 is associated with a total of 50 bytes. The key is the source IP address 1.1.1 and the value is 50.

At step 230, it is determined whether a function is determined for the partially aggregated trend result. The function identifies the nature of the value. Continuing with the previous example, where the key is the source IP address 1.1.1 and the value is 50, the function may be COUNT, such that the value of 50 represents the count of bytes associated with the source IP address 1.1.1.

If a function is identified, a set of related partially aggregated trend results are determined at step 240, for example using the key. Specifically, the partially aggregated trend results having the same key are merged, as is described at step 245.

At step 245, the related partially aggregated trend results are merged, for example by applying the function to the values of the related trend results. Each function may be modified or correlated to another function to accomplish the merging of values. For example, the COUNT function maps to a SUM function. A SUM function maps directly to a SUM function. A MIN function maps directly to a MIN function. A MAX function maps directly to a MAX function. An AVERAGE function maps to a SUM(Sum)/SUM(Count) function. As a result of the merge, a complete trend result or another partially aggregated trend result is determined.

Continuing with the previous example, the function of COUNT is translated to SUM, which is applied across the values of the related partially aggregated trend results. One partially aggregated trend result has the key source IP address 1.1.1, and a value of 50. Another partially aggregated trend result has the same key, but with a value of 20. Yet another partially aggregated trend result has the same key, but with a value of 30. As such, the SUM of 50, 20, and 30 is determined and the trend result (i.e., complete or partial) reflects a value of 100.

Processing continues from step 245 to step 210, where another partially aggregated trend result is received and processed, for example, in-memory of the manager. At step 250, it is determined whether the trend time interval has expired. The processing of partially aggregated trend results continues until a trend time interval has expired.

The trend result (i.e., complete or partial) is persisted at step 260, for example in a trend table of a database, upon expiration of the interval. In one embodiment, the trend result is persisted after the expiration of the interval and after a grace period. This grace period allows some partially aggregated trend results that are in the processing pipeline to be taken into account in the trend result.

If a function is not identified for a partially aggregated trend result at step 230, merging is not performed and processing ends.

Late and/or Out-of-Order Events

In one embodiment, events may be processed by the trend processor, for example of a manager, even if arriving late (beyond the grace period) and/or ort-of-order. For example, some part of the security network may have been down for a period of time, and agents from this part of the network were unable to send events. The following day, the agents send the previous day's events. Even though arriving late and/or out-of-order, these events may be used to generate a trend result (i.e. complete or partial).

The manager may detect that a received event is a late or out-of-order event. For example, if the event is for a time period that has been persisted, the event is an out-of-order event. The out-of-order events are processed in-memory and an in-memory aggregate result is determined, which is treated as a partially aggregated trend result.

The trend result (i.e., complete or partial) is determined, for example, as described by steps 220-245 of FIG. 2. In particular, a key and value is determined from the partially aggregated trend result. If a function is identified, related partially aggregated trend results are determined, for example, by querying a data store using the key. The data store includes persisted aggregated trend results. When the aggregated trend results were persisted, each trend result was treated as a complete result. After receiving the late and/or out-of-order events, the related aggregated trend results are treated as partially aggregated trend results. These persisted trend results are merged with the in-memory trend result. The trend result (i.e., complete or partial) is determined upon the merge and may be persisted, for example in an event and trend database. In one embodiment, the newly generated trend result may be used to update or otherwise refresh the previously persisted trend result.

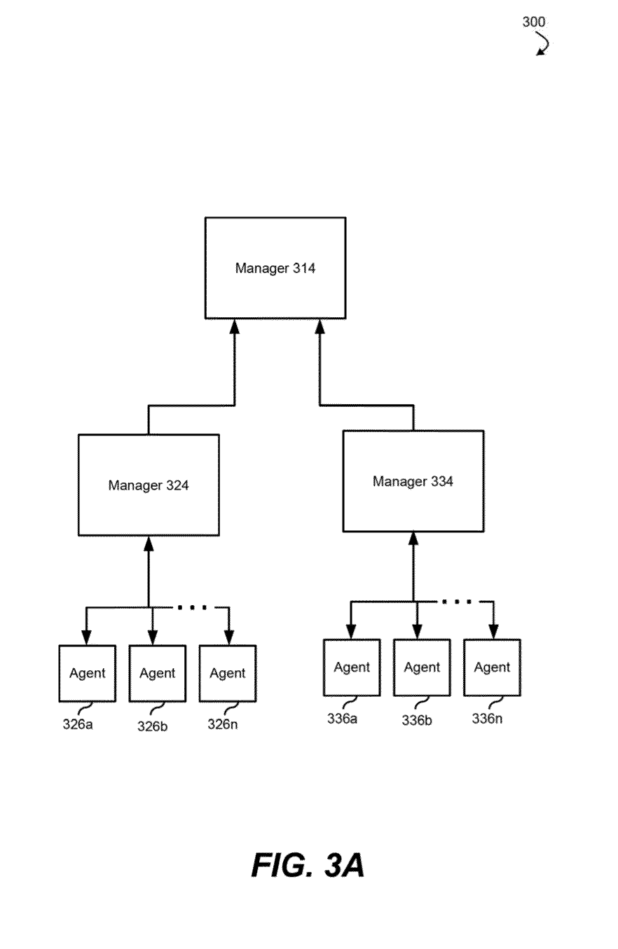

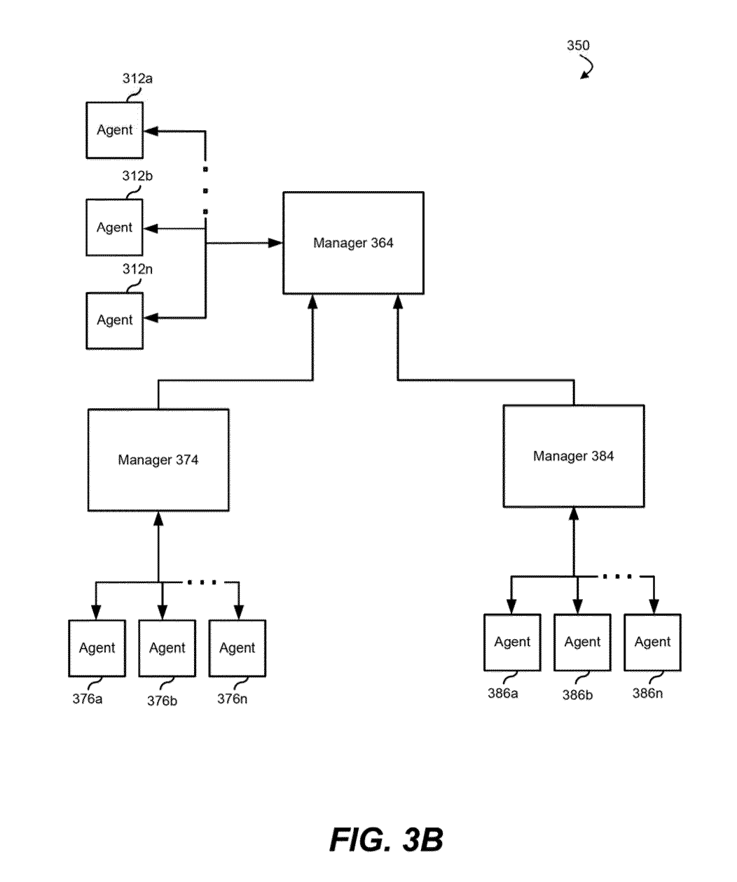

FIG. 3A is a topological block diagram of a network security system 300 including a dedicated manager of a plurality of managers in accordance with an embodiment. System 300 includes agents 326a-n, agents 336a-n, a dedicated manager 314, a manager 324, and a manager 334. As shown, agents 326a-n, agents 336a-n, and/or managers 314-334 are distributed in multiple platforms. Such distributed computing deployments provide load-balancing among the managers of system 300.

Agents 326a-n are software programs, which are machine readable instructions, that provide efficient, real-time (or near real-time) local event data capture and filtering from a variety of network security devices and/or applications. Agents 326a-n are operatively coupled to manager 324. At least one of agents 326a-n are configured to receive a set of events from a source, process the events by applying a filter associated with a trend on each event, and aggregate the trend results. An agent operates on events which it receives and does not have information on the events received by other agents. As such, the aggregated data provided by an agent is a trend result that is based on a partial set of events (e.g., partially aggregated trend result). In one embodiment, at least one of agents 326a-n do not have the capability of generating aggregated trend results and instead, provide event data messages comprising event data, rather than partially aggregated trend results, to manager 324.

Agents 336a-n are software programs, which are machine readable instructions, that provide efficient, real-time (or near real-time) local event data capture and filtering from a variety of network security devices and/or applications. Agents 336a-n are operatively coupled to manager 334. At least one of agents 336a-n are configured to receive a set of events from a source, process the events by applying a filter associated with a trend on each event, and aggregate the trend results. An agent operates on events which it receives and does not have information on the events received by other agents. As such, the aggregated data provided by an agent is a trend result that is based on a partial set of events (e.g., partially aggregated trend result). In one embodiment, at least one of agents 336a-n do not have the capability of generating aggregated trend results and instead, provide event data messages comprising event data, rather than partially aggregated trend results, to manager 334.

Manager 324 is operatively coupled to agents 326a-n and dedicated manager 314. Manager 324 is configured to generate partially aggregated trend results from events, generate partially aggregated trend results from other partially aggregated trend results (for example as received by agents or other lower-level managers), and/or forward partially aggregated trend results received from its sources (e.g., agents 326a-n) to dedicated manager 314. Specifically, to generate partially aggregated trend results from events, manager 324 is further configured to process the events received from its sources by applying a filter associated with a trend on each event, aggregating the trend results, and providing the aggregated trend results to manager 314. Similar to that of an agent, manager 324, in this distributed context, operates on events which it receives (or its sources receive) and does not have information on the events received by other managers, such as manager 334. As such, the aggregated data provided by manager 324 is a trend result that is based on a partial set of events (e.g. partially aggregated trend result).

Manager 334 is operatively coupled to agents 336a-n and dedicated manager 314. Manager 324 is configured to generate partially aggregated trend results from events, generate partially aggregated trend results from other partially aggregated trend results (for example as received by agents or other lower-level managers), and/or forward partially aggregated trend results received from its sources (e.g., agents 336a-n) to dedicated manager 314. Specifically, to generate partially aggregated trend results from events, manager 334 is further configured to process the events received from its sources by applying a filter associated with a trend on each event, aggregating the trend results, and providing the aggregated trend results to manager 314. Similar to that of an agent, manager 334, in this distributed context, operates on events which it receives (or its sources receive) and does not have information on the events received by other managers, such as manager 334. As such, the aggregated data provided by manager 334 is a trend result that is based on a partial set of events (e.g., partially aggregated trend result).

During configuration of the security system, the managers 324-334 may be configured to provide partially aggregated trend results to dedicated manager 314 for merging. In one embodiment, the trend results are those that are either generated by the manager from events, generated by the manager from other partially aggregated trend results, or are generated by an agent and forwarded by a manager. Dedicated manager 314 is operatively coupled to managers 324-334. Dedicated manager 314 is configured to perform the merging of partial results from other managers and to persist a trend result (i.e., complete or partial), for example in an event and trend database.

By distributing the processing of events among multiple managers and agents, the load on any single manager is reduced and the performance of system 300 is increased.

FIG. 3B is a topological block diagram of a network security system 350 including a master manager of a plurality of managers in accordance with an embodiment. System 350 includes agents 312a-n, 376a-n, agents 386a-n, a manager 364, a manager 374, and a manager 384. As shown, agents 312a-n, agents 376a-n, agents 386a-n, and/or managers 364-384 are distributed in multiple platforms. Such distributed computing deployments provide load-balancing among the managers of system 300. System 350 is similar to system 300 of FIG. 3A except that any one of managers 364-384 is configured to act as a master manager to merge the partial results. The partial results may be from the other managers and/or may have been generated by the master manager itself. The master manager is further configured to persist a trend result (i.e., complete or partial), for example in an event and trend database.

Real-Time Data

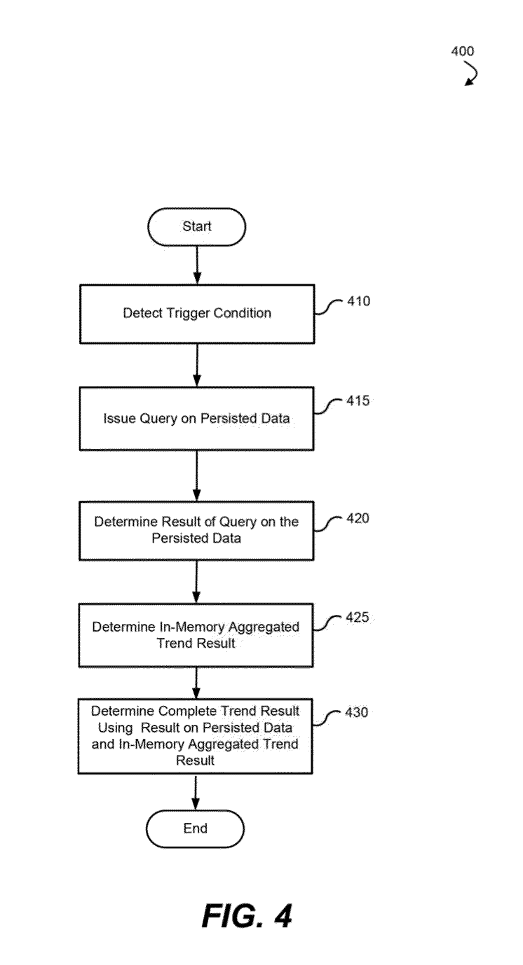

FIG. 4 is a process flow diagram for merging a persisted aggregated trend result and an in-memory aggregated trend result based on a detected trigger condition in accordance with an embodiment. The depicted process flow 400 may be carried out by execution of sequences of executable instructions. In another embodiment, various portions of the process flow 400 are carried out by components of a network security system, an arrangement of hardware logic, e.g., an Application-Specific Integrated Circuit (ASIC), etc. For example, blocks of process flow 400 may be performed by execution of sequences of executable instructions in a trend aggregation module of the network security system. The trend aggregation module may be deployed, for example, at a manager in the network security system.

In one embodiment, a particular condition may trigger the manager to merge a partially aggregated trend result from a persistent store and an in-memory trend result. At step 410, a trigger condition is detected.

One such condition is detecting a request for real-time data. For example, a query may be issued (e.g., by a user) requesting the total bandwidth used for the day. The time range of the total bandwidth query (i.e., one day) may be identified when the query is received, for example by the manager. For purposes of explanation, the query is issued at 3:30 pm, before the end of the day. An hourly trend may be tracking in a table the count of the total bandwidth information for each hour in the day. It should be noted that the time of the request is before the expiration of the current trend interval.

The manager determines that at least one result for the time range has been persisted. For the hourly trend, the aggregated trend result is persisted (in a record of the table) every hour throughout the day. As such, each record tracks the bandwidth count for one hour in a particular day. When the user's query is received, the persisted data is through 3:00 pm. However, there is newer data in memory. Specifically, the trend may be running in memory but is not persisted until the trend time interval expires at 4:00 pm. To provide the most up-to-date data, the merging of partially aggregated trend results may be employed. Specifically, a trend result from disk and an in-memory trend result may be merged.

At step 415, the query is issued on the persisted data. At step 420, the results of the query on the persisted data are determined. For example, the query result includes the records of hourly trends from the persistent store from midnight through 3:00 pm. The entire query result is treated as a partially aggregated trend result.

To provide a view of the real-time data, the in-memory data is used to determine an aggregated trend result, at step 425. Continuing with the previous example, this result is treated as a partially aggregated trend result that captures the events received from 3:01-3:30, which is the time the current trend interval began, and through the time of the request. The partially aggregated trend result is not persisted in order to expedite the final result to the user.

At step 430, a complete trend result is determined by merging the result on the persisted data and the in-memory aggregated trend result, for example, using the techniques described with respect to steps 220-245 of FIG. 2. The complete trend result may then be provided in response to the request for real-time data.

It should be recognized that the complete trend result may be discarded after the response is provided. Since the hourly trend continues to run and compute aggregate trend results, the events used to generate the in-memory aggregated trend result determined at step 425 are captured in the hourly trend. As such, the complete trend result may be discarded.

Typically, responses to queries are limited to persisted data, which may be stale at the time of query execution. By merging the in-memory trend result with the result on the persisted data, real-time data can be provided quickly and efficiently.

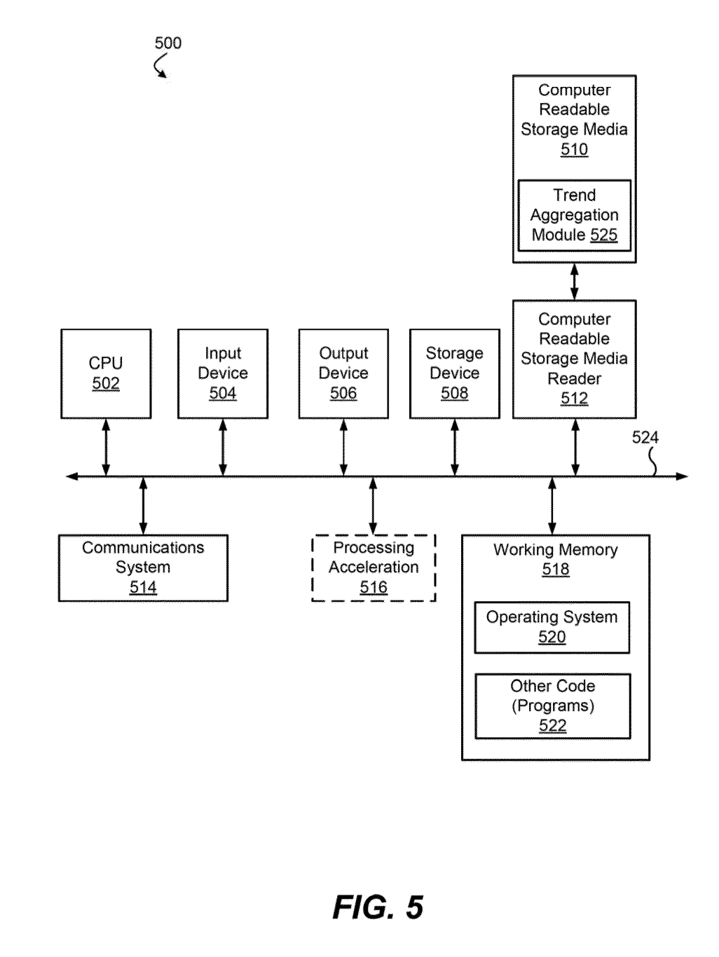

FIG. 5 illustrates a computer system in which an embodiment may be implemented. The system 500 may be used to implement any of the computer systems described above. The computer system 500 is shown comprising hardware elements that may be electrically coupled via a bus 524. The hardware elements may include at least one central processing unit (CPU) 502, at least one input device 504, and at least one output device 506. The computer system 500 may also include at least one storage device 508. By way of example, the storage device 508 can include devices such as disk drives, optical storage devices, solid-state storage device such as a random access memory (“RAM”) and/or a read-only memory (“ROM”), which can be programmable, flash-updateable and/or the like.

The computer system 500 may additionally include a computer-readable storage media reader 512, a communications system 514 (e.g., a modem, a network card (wireless or wired), an infra-red communication device, etc.), and working memory 518, which may include RAM and ROM devices as described above. In some embodiments, the computer system 500 may also include a processing acceleration unit 516, which can include a digital signal processor (DSP), a special-purpose processor, and/or the like.

The computer-readable storage media reader 512 can further be connected to a computer-readable storage medium 510, together (and in combination with storage device 508 in one embodiment) comprehensively representing remote, local, fixed, and/or removable storage devices plus any tangible non-transitory storage media, for temporarily and/or more permanently containing, storing, transmitting, and retrieving computer-readable information (e.g., instructions and data). Computer-readable storage medium 510 may be non-transitory such as hardware storage devices (e.g., RAM, ROM, EPROM (erasable programmable ROM), EEPROM (electrically erasable programmable ROM), hard drives, and flash memory). The communications system 514 may permit data to be exchanged with the network and/or any other computer described above with respect to the system 500. Computer-readable storage medium 510 includes a trend aggregation module 525, and may also include a trend data monitor.

The computer system 500 may also comprise software elements, which are machine readable instructions, shown as being currently located within a working memory 518, including an operating system 520 and/or other code 522, such as an application program (which may be a client application, Web browser, mid-tier application, etc.). It should be appreciated that alternate embodiments of a computer system 500 may have numerous variations from that described above. For example, customized hardware might also be used and/or particular elements might be implemented in hardware, software (including portable software, such as applets), or both. Further, connection to other computing devices such as network input/output devices may be employed.

The specification and drawings are, accordingly, to be regarded in an illustrative rather than a restrictive sense. It will, however, be evident that various modifications and changes may be made.

Each feature disclosed in this specification (including any accompanying claims, abstract and drawings), may be replaced by alternative features serving the same, equivalent or similar purpose, unless expressly stated otherwise. Thus, unless expressly stated otherwise, each feature disclosed is one example of a generic series of equivalent or similar features.

What is claimed is:

1. A method for processing aggregated query results, the method comprising:
determining a partially aggregated query result, wherein each query of a plurality of queries is executed on a plurality of events at a defined schedule and a time duration;
identifying a key and a value of the partially aggregated query result;
determining whether a function for the partially aggregated query result is identified;
determining a related partially aggregated query result of a plurality of partially aggregated query results using the key; and
merging, at a local memory of a computing device, the partially aggregated query result and the related partially aggregated query result.

2. The method of claim 1, wherein merging comprises:
applying the function to the value of the partially aggregated query result and the value of the related partially aggregated query result.

3. The method of claim 1, further comprising:
storing a complete aggregation of the query result in a persistent storage, wherein the complete aggregation of the query result is determined upon merging the partially aggregated query result and the related partially aggregated query result.

4. The method of claim 1, wherein the partially aggregated query result is generated by a distributed manager of a network system, and the partially aggregated query result is received by a local manager of the network system.

5. The method of claim 1, further comprising:
detecting a query for real-time data;
issuing the query for real-time data on a persistent storage, wherein the persistent storage includes the plurality of partially aggregated query result;
determining a result of issuing the query on the persistent storage; and
determining an in-memory aggregation of the query for real-time data, wherein the complete aggregation of the query result is generated using the result of issuing the query on the persistent storage and the in-memory aggregation.

6. The method of claim 1, further comprising:
receiving, at a local memory of the computing device, a plurality of events in an event stream;
determining the plurality of events are out-of-order events;
determining a query result for each of the plurality of events; and
determining a partially aggregated query result based on the query result for each of the plurality of events.

7. A system for processing partially aggregated query results, the system comprising:
a persistent store for storage of partially aggregated query results and complete query results; and
a computer that includes:
a trend aggregation module; and
a memory for merging of partially aggregated query results;
wherein the trend aggregation module is configured to:
determine a partially aggregated query result, wherein each query of a plurality of queries is executed on a plurality of events at a defined schedule and a time duration;
identify a key and a value of the partially aggregated query result;
determine whether a function for the partially aggregated query result is identified;
determine a related partially aggregated query result of a plurality of partially aggregated query results using the key; and
merge the partially aggregated query result and the related partially aggregated query result.

8. The system of claim 7, wherein merging comprises:
applying the function to the value of the partially aggregated query result and to the value of the related partially aggregated query result.

9. The system of claim 7, wherein the trend aggregation module is further configured to:
store a complete query result in the persistent storage, wherein the complete query result is determined upon the partially aggregated query result and the related partially aggregated query result.

10. The system of claim 7, wherein the trend aggregation module is further configured to:
detect a query for real-time data;
issue the query for real-time data on the persistent storage;
determine a result of issuing the query on the persistent storage; and
determine an in-memory aggregation of the query for real-time data, wherein a complete aggregation of the query result is generated using the result of issuing the query on the persistent storage and the in-memory aggregation.

11. The system of claim 7, wherein the memory is further configured to receive a plurality of events in an event stream, and wherein the trend aggregation module is further configured to:
determine the plurality of events are out-of-order events;
determine a query result for each of the plurality of events; and
determine a partially aggregated query result based on the query result for each of the plurality of events.

12. A non-transitory computer-readable medium storing a plurality of instructions to control a data processor to process partially aggregated query results, the plurality of instructions comprising instructions that cause the data processor to:
determine a partially aggregated query result, wherein each query of a plurality of queries is executed on a plurality of events at a defined schedule and a time duration;
identify a key and a value of the partially aggregated query result;
determine whether a function for the partially aggregated query result is identified;
determine a related partially aggregated query result of a plurality of partially aggregated query results using the key; and
merge, at a local memory of a computing device, the partially aggregated query result and the related partially aggregated query result.

13. The non-transitory computer-readable medium of claim 12, wherein the instructions that cause the data processor to merge comprise instructions that cause the data processor to apply the function to the value of the partially aggregated query result and the value of the related partially aggregated query result.

14. The non-transitory computer-readable medium of claim 12, wherein the plurality of instructions further comprise instructions that cause the data processor to:
detect a query for real-time data;
issue the query for real-time data on a persistent storage, wherein the persistent storage includes the plurality of partially aggregated query results;
determine a result of issuing the query on the persistent storage; and
determine an in-memory aggregation of the query for real-time data, wherein the complete aggregation of the query result is generated using the result of issuing the query on the persistent storage and the in-memory aggregation.

15. The non-transitory computer-readable medium of claim 12, wherein the plurality of instructions further comprise instructions that cause the data processor to:
receive a plurality of events in an event stream;
determine the plurality of events are out-of-order events;
determine a query result for each of the plurality of events; and
determine a partially aggregated query result based on the query result for each of the plurality of events.
